(19) United States
(12) Patent Application Publication
(10) Pub. No.: US 2019/0285528 A1
(43) Pub. Date: Sep. 19, 2019

(54) System for Testing Fluid Samples

(71) Applicant: Ametek, Inc., Berwyn, PA (US)

(72) Inventors: Daniel William Castell, Broken Arrow, OK (US); Thomas Steele, Broken Arrow, OK (US); Thomas Hicks, Broken Arrow, OK (US); William John Willems, Broken Arrow, OK (US)

(73) Assignee: Ametek, Inc., Berwyn, PA (US)

(21) Appl. No.: 15/920,631

(22) Filed: Mar. 14, 2018

(51) Int. Cl. G01N 11/08; G01F 7/00

(52) U.S. Cl. CPC G01N 11/08; G01F 7/005

(57) ABSTRACT

A system and method for measuring flow resistance of a fluid in a conduit is provided. The system generally includes a reservoir for containing the fluid, a pump connected to the reservoir for distributing the fluid through a conduit having a straight measurement section, one or more pressure sensors connected to the conduit for measuring the pressure of the fluid in the conduit at one end of the straight measurement section and an opposite end of the straight measurement section.

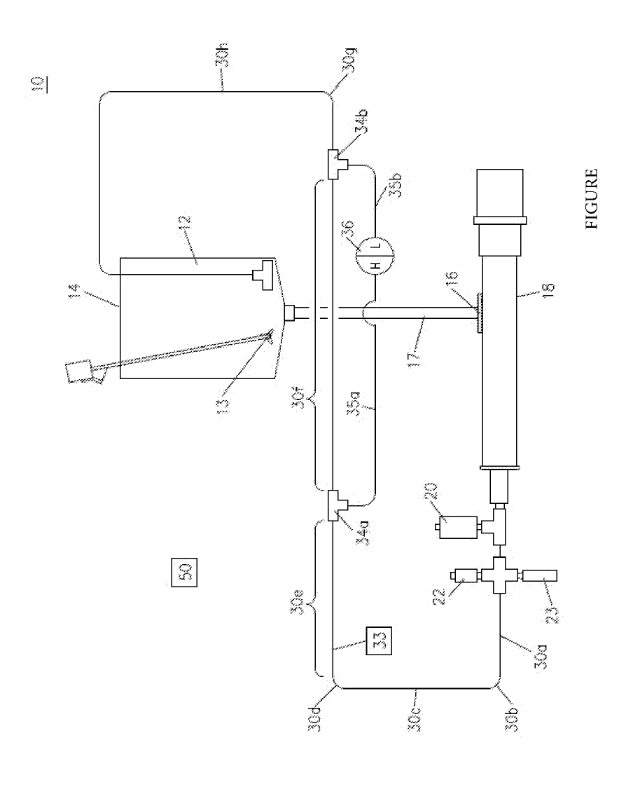

### FIELD OF THE INVENTION

The present invention relates to a system for testing fluid samples. More particularly, the invention relates to a system for measuring the flow resistance of fluid samples.

### BACKGROUND OF THE INVENTION

As is described in U.S. Patent App. Pub. No. 2014/0060175, which is incorporated herein by reference in its entirety, fluid flow through a pipe may incur resistance by friction between the flowing fluid and the interior surface of the pipe, turbulence in the flowing fluid, and deviations and/or restrictions in the flow path, among other factors. Pressure drop resulting from the resistance to flow may be determined by the use of a “friction loop.” A friction loop is a conduit through which a fluid under test flows. Pressure sensors can be connected to the conduit at spaced apart locations along the conduit. The measured differential pressure between the pressure sensors is related to the pressure drop in the conduit, and provides a direct measurement of pressure loss in the pipe due to flow.

It is known in the art to modify the fluid flow characteristics of fluids by adding chemicals such as friction modifiers and viscosity modifiers, among other chemicals. The friction loop (with the pressure sensors) is used to measure the flow resistance in pipe, which measurements can be used to optimize the effectiveness of chemical treatments to reduce fluid flow resistance in pipe.

Conventional friction loops are large, typically having conduits that may be on the order of 30 feet in length, for example. As a result of their large size, conventional friction loops consume a considerable amount of electricity during operation (due to pumping the fluid), and generate significant waste (in the form of, at least, waste fluid). Various conventional friction loops have addressed this problem by using smaller coiled conduits (e.g., ten feet in length), however it has been found that the inertial effects of the fluid flowing through the coiled conduit can corrupt the measurement data.

What was sought is a friction loop system having a small compact footprint that produces less waste and requires less energy to operate as compared with conventional friction loops.

### BRIEF DESCRIPTION OF THE DRAWING

The above-mentioned and other features and advantages of this invention, and the manner of attaining them, will become more apparent and the invention will be better understood by reference to the following description of an embodiment of the invention taken in conjunction with the accompanying drawings, wherein:

The sole FIGURE is a schematic view of a system for testing fluids.

### DETAILED DESCRIPTION OF THE INVENTION

Corresponding reference characters indicate corresponding parts throughout the several views. The exemplification set out herein illustrates an embodiment of the invention, in one form, and such exemplification is not to be construed as limiting the scope of the invention in any manner.

Referring now to the sole FIGURE, that FIGURE depicts a system 10 for testing fluids. The system 10 generally comprises a fluid preparation reservoir 12 (reservoir 12 hereinafter) for containing fluid. A mixer 13 is positioned in the reservoir 12 for mixing the fluid within the reservoir 12. The reservoir 12 includes an open end 14 for receiving fluid, and an outlet 16 for delivering fluid into a pump 18. The outlet 16 may be provided on the reservoir 12 itself, or a pipe 17 that is connected to the reservoir 12.

The outlet 19 of the pump 18 is fluidly connected to an apparatus 20 for flow conditioning and pulse damping the fluid delivered from the pump 18. The outlet of the apparatus 20 is connected to both an over pressure protection device 22 and a discharge pressure transducer 23.

The discharge pressure transducer 23 is a pressure sensor that is configured for measuring the pressure of the flow conditioned and pulse dampened fluid output by the pump 18. The over-pressure protection device 23 is connected to the pressure transducer 22 to prevent an over-pressure condition in the system 10. The outlet of the pressure transducer 22 is connected to a conduit 30.

The conduit 30 forms a loop for delivering fluid to and from the reservoir 12. The conduit 30 includes (in downstream order) a first straight section 30a, a 90 degree bend 30b, another straight section 30c, another 90 degree bend 30d, a flow development section 30e, a straight and linear measurement section 30f, another 90 degree bend 30g and a return section 30h. The sections 30a-30h are interconnected. Each section has a defined length and diameter (assuming the section is circular). The diameter of each section may be equal, for example.

The flow development section 30e of the conduit 30 is a linear, horizontal length of tubing positioned downstream of the bend 30d and upstream of the measurement section 30f. The flow development section 30e facilitates flow regime development to minimize effects of disturbances from tubing bends on the desired pressure measurement at the ports 34a and 34b. In simple terms, the length of the conduit provided by the section 30e is sufficiently long to normalize any disturbances in the fluid. It is noted that the flow development section 30e (as well as the measurement section 30f) is devoid of any bends.

The length to diameter ratio of the flow development conduit section 30e is carefully controlled. As noted above, the purpose of the flow development section 30e is to provide sufficient length for the velocity profile of the fluid to recover from the bends 30b and 30d. Research has shown that the appropriate length to diameter ratio of the section 30e should be at least 50, however, recovery of the velocity profile can occur at ratios greater than 20.

A ninety degree bend can also have an impact on the velocity profile of the fluid at a location upstream of a bend. Research has shown that the appropriate length to diameter ratio of a conduit upstream of a bend should be at least 10. Accordingly, the length to diameter ratio of the section of conduit 30 spanning from port 34b to the bend 30g should be at least 10.

The effects caused by a 90 degree bend are described in greater detail in the article Turbulent Pipe Flow Through a 90 Degree Bend by Hellostrom et al., which may be found at http://www.tsfp-conference.org/proceedings/2011/6a1p.pdf, published January 2007, and is incorporated by reference herein in its entirety.

The measurement section 30f is a linear, horizontal length of tubing across which the differential pressure is measured to determine the pressure drop and resulting percent friction reduction.

A temperature measurement probe 33 is connected to the section 30e for measuring the temperature of the fluid within the section 30e.

An upstream pressure measurement port 34a is connected at the upstream end of the straight and linear measurement section 30f, and a downstream pressure measurement port 34b is connected at the downstream end of the straight and linear measurement section 30f. A differential pressure transducer 36 is connected to both ports 34a and 34b. More particularly, the high pressure side of the transducer 36 is connected to the port 34a via a conduit 35a, and the low pressure side of the transducer 36 is connected to the port 34b via a conduit 35b. It should be understood that the conduits 35a and 35b are not fluidly connected, thus, fluid does not pass from conduit 35a to 35b, or vice versa.

None of the ports 34a and 34b, the conduits 35a and 35b and the transducer 35 disturb the flow of fluid through the measurement section 30f of the conduit 30.

A control unit 50 is connected by either a wired connection or a wireless connection to (at least) components 13, 18, 23, 33 and 36 for receiving data from those components and/or transmitting instructions to those components. The control unit 50 includes a processor for processing information.

Referring now to various individual components of the system 10, the pump 18 is a low-shear, progressive-cavity, positive displacement pump. The pump 18 is configured to minimize shearing of fluids in order to maintain the integrity of the treatment chemicals, particularly for small volume samples, and minimize the effect of recirculation of fluids on performance over time. A suitable pump is offered by the Seepex Corporation. It should be understood that the pump 18 may vary from that which is shown and described.

The apparatus 20 for flow conditioning and pulse damping damps any pressure or flow pulses in the fluid exiting from pump 18. The apparatus 20 reduces physical signal noise, as opposed to electrical noise, to enable accurate measurements of low-level signals. A suitable apparatus 20 is offered by the Swagelok Corporation.

The temperature measurement probe 33 is a non-wetted probe that measures the temperature of the fluid just upstream of the measurement section 30f without inducing flow disturbances. The temperature data transmitted by the probe 33 can be important for evaluating the health of the system 10 over time. As is described below, if the fluid in the system 10 exceeds a predetermined temperature, then the pressure measurement data can become skewed.

The differential pressure transducer 36 is a stable, high-accuracy, high-precision transducer for measuring the pressure drop across the measurement section 30f. The differential pressure transducer 36 is scaled appropriately for the highest potential differential pressure. The transducer 36 has the capability and long-term stability to reliably measure very small differential pressures for accurate, repeatable results. A suitable differential pressure transducer is offered by the Tecsis LP Company.

Referring now the method of using the system 10, the system 10 is intended for use in evaluating the efficacy of additive treatments in modifying the properties of a base fluid, often, but not exclusively, for the purpose of reducing resistance to flow. The percent friction reduction generated by a particular treatment added to the base fluid is determined using the system 10 by measuring the actual pressure drop across the measurement section 30f both before the treatment is added to the base fluid and again after the treatment is added to the base fluid.

More particularly, according to one exemplary method of using the system 10, the reservoir 12 is first filled with an aqueous or non-aqueous base fluid, such as water, and (optionally) salt or similar chemicals. The pump 18 is then operated at 4 gallons per minute to circulate the base fluid through the system 10 during the (entire) measurement process. The volumetric flow rate corresponds to the required pump discharge pressure for all allowable base fluids flowing through the system 10 (diameter, total length, and number and type of restrictions), such that the required pump horsepower is able to be supplied using the electrical power available at North American laboratory benches.

Using the pump 18, the base fluid is then circulated through the system 10 (i.e., from reservoir 12, through pump 18, through conduit sections 30a-30h, and returned to reservoir 12) for a determined period of time (e.g., one minute). The fluid pressure in the system 10 stabilizes within about 20 seconds of starting the circulation process.

On the fluid's first pass through the system 10, the conduits 35a and 35b leading to the pressure transducer 36 become filled with the base fluid. Thereafter, the fluid within the conduits 35a and 35b remains relatively stationary such that the fluid pressure within the conduits 30e and 30f is transmitted to the transducer 36 via the stationary fluid within the conduits 35a and 35b. Note that the conduits 35a and 35b are disposed at an elevation beneath the conduit section 30f and terminate at a dead-end at the transducer 36, thus, the conduits 35a and 35b remain filled with stationary fluid during operation. Because the fluid within the conduits 35a and 35b remains relatively stationary during operation of the system 10, the bends in the conduits 35a and 35b do not disturb the velocity profile of the fluid within the conduits 30e and 30f.

After the system 10 has stabilized, the differential pressure across the section 30f is measured at the ports 34a and 34b of the measurement section 30f using the transducer 36 for about thirty seconds, for example. The measured differential pressure is averaged over that time using the control unit 50 (this is the untreated differential pressure value).

The operator then informs the control unit 50 that the treatment will be added to the base fluid by entering a command (for example) on the control unit 50. The treatment, such as friction modifiers and viscosity modifiers, among other chemicals and modifying components, are then added to the base fluid in the reservoir 12 and mixed by the mixer 13. The treated fluid is circulated through the system 10, in the same way as described above, for a second determined period of time (e.g., five minutes). The treated fluid may be circulated through the system while the user adds the treatment to the base fluid in the reservoir 12. The fluid is circulated for no longer than five minutes (for example) because the fluid temperatures becomes less stable (as measured by the probe 33) thereby resulting in measurement errors of the differential pressure.

The differential pressure of the treated base fluid at the ports 34a and 34b of the measurement section 30f is measured using the transducer 36 (this is the treated differential pressure value). The treated differential pressure value is a live measurement value, in contrast to the untreated differential pressure value that is averaged over time. The control unit 50 then calculates the percentage difference between the untreated differential pressure value (averaged) and the treated differential pressure value (live). The control unit 50 reports to a user (via a display, for example) the calculation over the second determined period of time as the percent friction reduction attributed by the treatment added to the base fluid.

The live treated differential pressure value is tracked by the control unit 50 and reported to the user of the system 10 for determining or analyzing the following: (i) the response time of the added treatment, (ii) the peak percentage friction reduction for that treatment, and (ii) changes in the percentage friction reduction over time.

It is to be understood that the above-described operating steps are performed by the controller of the control unit 50 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller described herein, such as the aforementioned method of operation, is implemented in software code or instructions which are tangibly stored on the tangible computer readable medium. Upon loading and executing such software code or instructions by the controller, the controller may perform any of the functionality of the controller described herein, including any steps of the aforementioned method described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

The system 10 confers several advantages over convention friction loops as a result of the short length of the conduit 30. First, the system 10 has a relatively small footprint and low overall weight as a result of (at least) the short length of the conduits 30e and 30f. As a result of its small size and low weight, the system 10 can be mounted on a benchtop and can be portable, unlike conventional friction loops. Moreover, the preferred embodiment incorporates a rigid frame and dimensions to enable the system 10 to operate either permanently installed in a stationary facility or as a temporary installation or mounted in mobile facilities.

Because the conduit 30 is relatively short, less fluid is required to flush the system 10 after operation, thereby resulting in less waste fluid. Also, the pump 18 of the system 10 requires less power for pushing the fluid through the shorter length of the conduit 30, thereby resulting in an energy savings as compared with conventional friction loops.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system for measuring flow resistance of a fluid in a conduit, said system comprising:
a reservoir for containing the fluid;
a pump connected to the reservoir for distributing the fluid through a conduit having a straight measurement section; and
one or more pressure sensors connected to the conduit for measuring the pressure of the fluid in the conduit at one end of the straight measurement section and an opposite end of the straight measurement section.

2. The system of claim 1 wherein the straight measurement section is devoid of bends.

3. The system of claim 1, wherein the conduit includes a bend and the straight measurement section is downstream of the bend and separated from the bend by a straight flow development section of the conduit.

4. The system of claim 3, wherein a length to diameter ratio of the straight flow development section is at least twenty.

5. The system of claim 3, wherein a length to diameter ratio of the flow development section is at least fifty.

6. The system of claim 1, wherein the conduit includes a bend and the straight measurement section is upstream of the bend.

7. The system of claim 6, wherein a straight length of conduit spanning the bend and the straight measurement section has a length to diameter ratio of at least ten.

8. The system of claim 1, wherein the pressure sensor is a pressure transducer that is fluidly connected to the straight measurement section at two different locations.

9. The system of claim 1 further comprising a temperature probe connected to the conduit for measuring a temperature of the fluid within the conduit at a location upstream of the straight measurement section.

10. The system of claim 1 further comprising a control unit for comparing the pressure measurement at said one end of the straight measurement section with the pressure measurement at said opposite end of the straight measurement section, and calculating the flow resistance of the fluid based upon said comparison.

11. The system of claim 1, wherein the system is close-ended such that the system is capable of continuously circulating the fluid through the system.

12. The system of claim 1, wherein the pump is a low-shear pump that is configured to minimize shearing of the fluid.

13. A method of measuring flow resistance of a fluid in a conduit, said method comprising the steps of:
a) distributing base fluid into a conduit having a straight measurement section;
b) circulating the base fluid through the conduit for a first predetermined amount of time;
c) continuously measuring the pressure of the base fluid at a first end of the straight measurement section over the first predetermined amount of time;
d) continuously measuring the pressure of the base fluid at a second end of the straight measurement section over the first predetermined amount of time; and
e) calculating an average flow resistance of the base fluid over the first predetermined amount of time as a function of a difference between the measurements at steps c) and d);
f) distributing a treated fluid comprising the base fluid and a chemical treatment into the conduit;
g) circulating the treated fluid through the conduit for a second predetermined amount of time;
h) continuously measuring the pressure of the treated fluid at the first end of the straight measurement section over the second predetermined amount of time;
i) continuously measuring the pressure of the treated fluid at the second end of the straight measurement section over the second predetermined amount of time;
j) calculating the flow resistance of the treated fluid over the second predetermined amount of time as a function of a difference between the measurements at steps h) and i); and
k) calculating a percentage friction reduction attributed to the chemical treatment by comparing the flow resistance of the treated fluid calculated at step j) over the second predetermined amount of time with the average flow resistance of the base fluid calculated at step e).

14. The method of claim 13, wherein the circulating steps b) and g) comprises circulating the base fluid and the treated fluid, respectively, through a bend in the conduit, then through a straight flow development section of the conduit, and then through the straight measurement section.

15. The method of claim 14, wherein a length to diameter ratio of the straight flow development section is at least twenty.

16. The method of claim 14, wherein a length to diameter ratio of the straight flow development section is at least fifty.

17. The method of claim 14, wherein the circulating steps b) and g) comprises circulating the base fluid and the treated fluid through the straight measurement section, and then through a straight portion of the conduit, and then through a second bend, wherein the straight portion has a length to diameter ratio of at least ten.

18. The method of claim 14 further comprising the step of measuring a temperature of the treated fluid within the conduit.

19. The method of claim 14 further comprising the step of calculating a peak percentage friction reduction over the second predetermined amount of time.

20. The method of claim 14 further comprising the step of tracking the percentage friction reduction over the second predetermined amount of time.
